(19) United States
(12) Patent Application Publication
(10) Pub. No.: US 2004/0062962 A1
(43) Pub. Date: Apr. 1, 2004

(54) Cell unit having fuel cell, electronic apparatus having fuel cell, and controlling method of operation of fuel cell in multi-step manner for efficient operation

(75) Inventor: Akihiro Ozeki, Tokyo (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/424,001

(22) Filed: Apr. 25, 2003

(30) Foreign Application Priority Data
Sep. 30, 2002 (JP) JP2002-287891

(51) Int. Cl. H01M 8/04; H01M 16/00

(52) U.S. Cl. 429/22; 429/23; 429/9; 429/13

(57) ABSTRACT

An electronic apparatus has a fuel cell for generating electric power with a reaction portion and an auxiliary mechanism for fuel supply to the reaction portion, an electronic device being operable with the electric power provided from said fuel cell, and a control unit coupled to the auxiliary mechanism. The control unit controls an amount of fuel supply by the auxiliary mechanism in a multi-step manner.

### CROSS-REFERENCE TO RELATED APPLICATIONS

This application is based upon and claims the benefit of priority from Japanese Patent Application No. 2002-287891, filed Sep. 30, 2002, the entire contents of which are incorporated herein by reference.

### BACKGROUND OF THE INVENTION

1. Field of the Invention

This invention relates to a fuel cell for generating electric power, and also an electronic apparatus, such as a portable computer, which incorporates the fuel cell.

2. Description of the Related Art

In these years, various kinds of electronic devices that may be driven by batteries, such as a mobile information terminal called a Personal Digital Assistant (hereinafter PDA), a personal (mobile) computer, and a digital camera, have been developed and widely used.

At the same time, in recent years, special attention has been focused upon environmental problems, and eco-friendly batteries have been actively developed. A direct methanol fuel cell (hereinafter DMFC) is well known as a battery of this kind.

In the DMFC, methanol and oxygen, which are supplied as fuel components, are subjected to a chemical reaction, and electric energy is obtained by the chemical reaction. The DMFC has a structure in which an electrolyte is interposed between two electrodes formed of porous metal or carbon. See, “NENRYO DENCHI NO SUBETE” (“ALL ABOUT FUEL CELLS”)), Hironosuke IKEDA, Kabushiki-Kaisha Nihon Jitsugyo Shuppansha, Aug. 20, 2001, pp. 216-217 incorporated herein by reference. There is a strong demand for practical use of the DMFC, since it produces no harmful waste.

In order to increase an output power per volume of the DMFC, a methanol solution and air (oxygen) are fed by means of pumps. Thus, in the DMFC, the pumps which are auxiliary mechanisms (hereinafter auxiliary) consume electric power. Therefore, in the case where a required total consumption power is small, the ratio of the consumption power required by the auxiliary to the total consumption power becomes large. This may deteriorate the fuel consumption efficiency.

### BRIEF SUMMARY OF THE INVENTION

Embodiments of the present invention provide an electronic apparatus accompanying a fuel cell unit which supplies with electric power.

According to embodiments of the present invention, an electronic apparatus includes a fuel cell which has a reaction portion and an auxiliary mechanism, for fuel supply to the reaction portion for generating electric power, an electronic device being operable with the electric power provided from the fuel cell, and a control unit coupled to the auxiliary mechanism, for controlling an amount of fuel supply by the auxiliary mechanism in a multi-step manner.

Additional features and advantages of embodiments of the present invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a portable personal computer according to a first embodiment of the present invention;

FIG. 2 is a block diagram showing a schematic structure of a fuel cell unit in the portable personal computer according to the first embodiment;

FIG. 3 is a block diagram showing a schematic structure of an auxiliary-type DMFC in the fuel cell unit according to the first embodiment;

FIG. 4 is a diagram showing transition of output states carried by the fuel cell unit according to the first embodiment;

FIG. 5 is a graph showing an effect of multi-step control carried out by the fuel cell unit according to the first embodiment;

FIG. 6 is a block diagram showing a schematic structure of a fuel cell unit according to a second embodiment of the present invention;

FIG. 7 is a block diagram showing a schematic structure of a fuel cell unit according to a third embodiment of the present invention;

FIG. 8 is a block diagram showing a schematic structure of a fuel cell unit according to a fourth embodiment of the present invention;

FIG. 9 is a graph showing an effect of multi-step control carried out by the fourth embodiment; and

FIG. 10 is a diagram showing an alarm voltage and a dangerous voltage as voltages of a DMFC cell stack set by the fuel cell unit according to the fourth embodiment.

### DETAILED DESCRIPTION

Preferred embodiments according to the present invention will be described hereinafter with reference to the accompanying drawings.

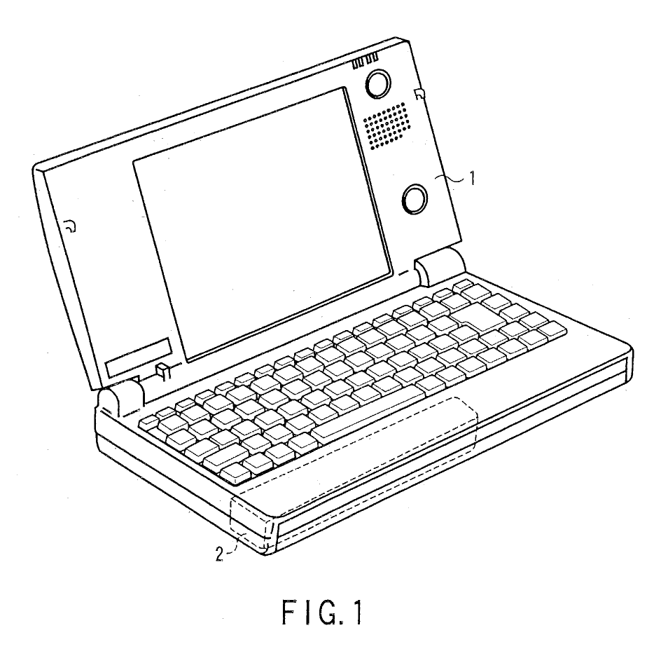

FIG. 1 shows an external appearance of an electronic apparatus according to a first embodiment of the present invention.

As shown in FIG. 1, an electric apparatus 1 of this embodiment is a portable personal computer. A fuel cell unit 2 is accommodated within a main body of the electronic apparatus 1. The fuel cell unit 2 supplies the electronic apparatus 1 with electric power, and the electronic apparatus 1 operates with the electric power. The fuel cell unit 2 is designed to be easily detachable and replaceable with a new fuel cell or the same fuel cell after refilling the fuel.

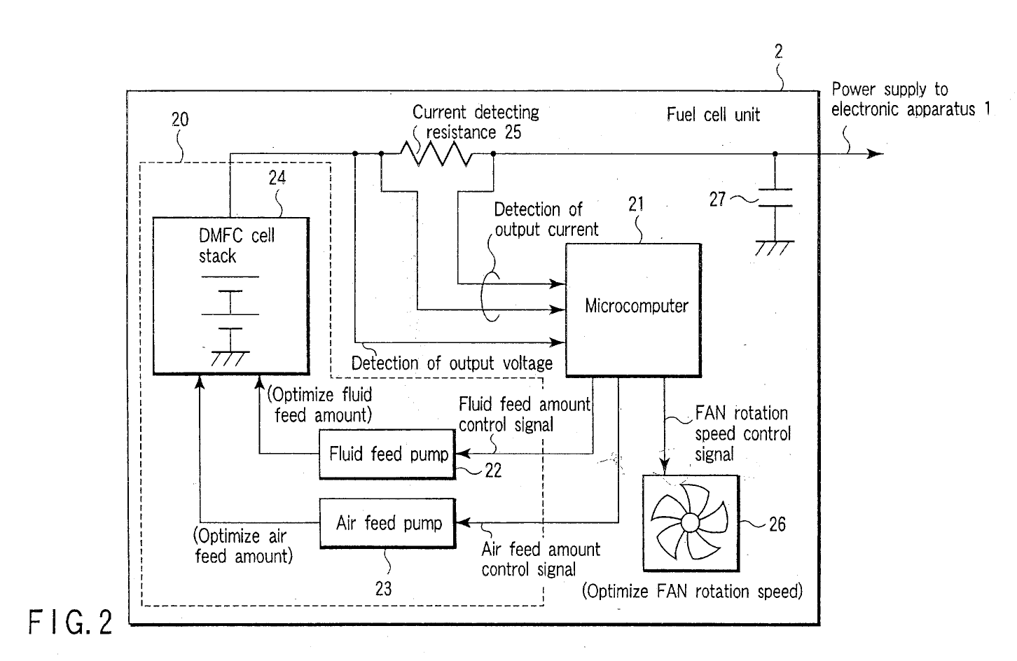

FIG. 2 is a schematic structure of the fuel cell unit 2.

As shown in FIG. 2, the fuel cell unit 2 includes a auxiliary-type DMFC 20, and a microcomputer 21. The auxiliary-type DMFC 20 has a fluid feed pump 22, an air feed pump 23, and a DMFC cell stack 24. The fuel cell unit 2 also includes a current-detecting resistance 25, a fan 26 and a capacitor 27.

The microcomputer 21 controls all operations of the fuel cell unit 2. More specifically, the microcomputer 21 monitors an output voltage and an output current from the DMFC cell stack 24 to the electronic apparatus 1 and detects the output power at that time. Based on the result of the detection, the microcomputer 21 controls the operations of the fluid feed pump 22, air feed pump 23, and fan 26.

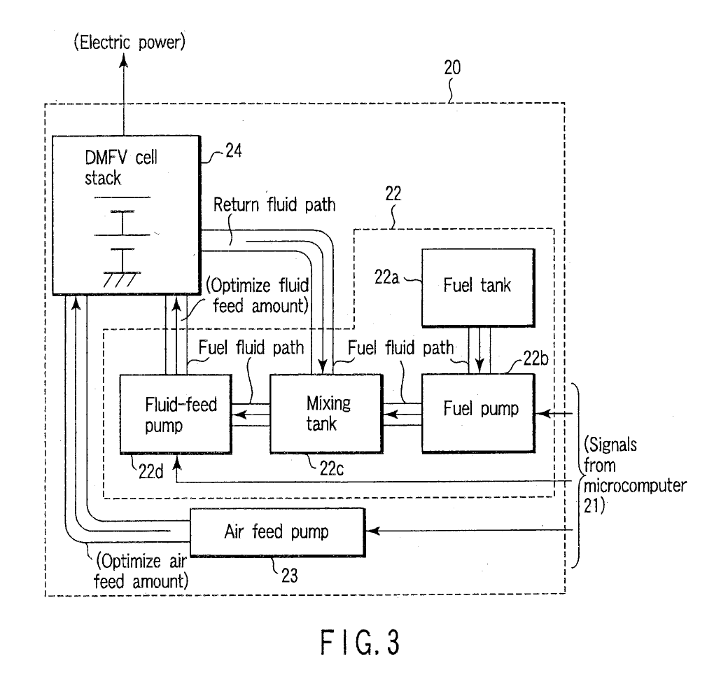

The auxiliary-type DMFC 20, as shown in FIG. 3, includes a fuel tank 22a, a fuel pump 22b, a mixing tank 22c, a fluid feed pump 22d, the air feed pump 23, and the DMFC cell stack 24. The fuel tank 22a is a cartridge type container that contains methanol to be used as fuel by the auxiliary-type DMFC 20. The fuel tank 22a is detachably disposed within the fuel cell unit 2 to permit replacement and/or refueling of it. The auxiliary-type DMFC 20 is a DMFC of the type wherein methanol in the fuel tank 22a and air are positively taken in by an auxiliary such as the fuel pump 22b, the fluid feed pump 22d, and the air feed pump 23. The fluid feeding amount of methanol by the fuel pump 22b and the fluid feed pump 22d both in the fluid feed pump 22, and the air feeding amount by the air feed pump 23 are controlled on the basis of a control signal transmitted from the microcomputer 21.

Methanol in the fuel tank 22a is fed into the mixing tank 22c through a fuel fluid path by the fuel pump 22b and vaporized therein. The vaporized methanol is fed to the DMFC cell stack 24 by the fluid feed pump 22d through a feed fluid path. Air is fed to the DMFC cell stack 24 by the air feed pump 23. The oxygen in the air and the vaporized methanol react with each other to generate electric power.

The DMFC cell stack 24 causes methanol fed from the fuel pump 22b and the fluid feed pump 22d and air (oxygen) fed from the air feed pump 23 to react with each other and outputs the electric power thus generated by the chemical reaction. The output power is determined by the output amounts from the fuel pump 22b, the fluid feed pump 22d, and air feed pump 23.

Also, water is generated as a result of the chemical reaction, and is returned to the mixing tank 22c through a return fluid path.

The current-detecting resistance 25 is provided for the microcomputer 21 to detect an output current from the DMFC cell stack 24 to the electronic apparatus 1.

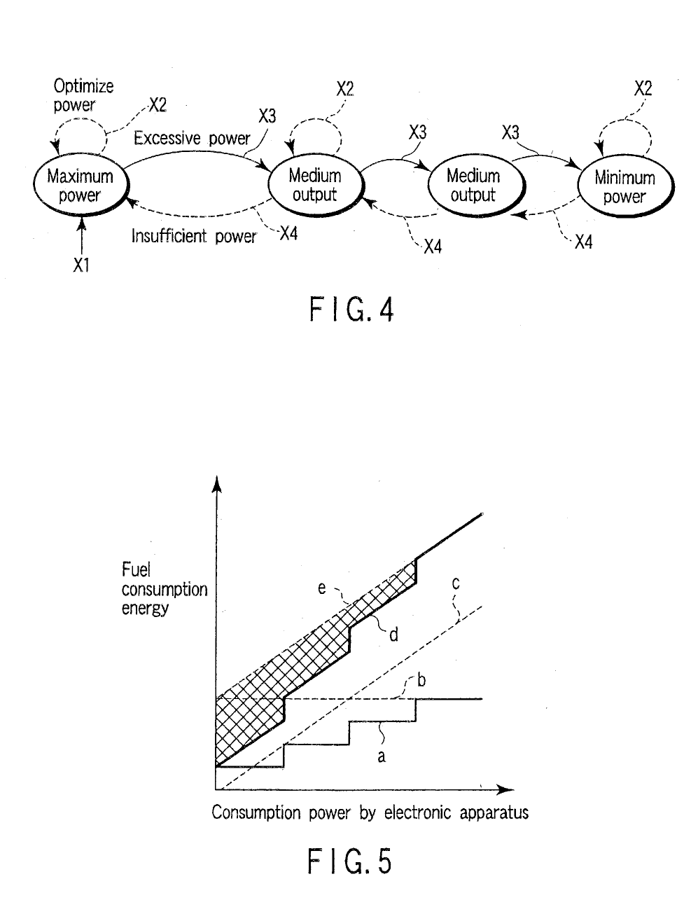

Next, the principle of the control of the operation of the fuel cell unit 2 having the above-described structure will now be described with reference to FIG. 4.

The microcomputer 21 controls the output power of the fuel cell unit 2, more specifically, the fuel supply amounts of the fluid feed pump 22, i.e. the fuel pump 22b and the fluid feed pump 22d, and the air supply amounts of the air feed pump 23 and the rotation rate of the fan 26. The microcomputer 21 performs the control of these output amounts in multi-steps as follows:

(X1) At the start of operation, when the necessary power is still unknown, the apparatus is operated at the maximum output.

(X2) When the current output power is appropriate for the demand of the electronic apparatus 1, the current output is maintained.

(X3) When the current output power is excessive for the demand of the electronic apparatus 1, the current output is reduced to a level one step lower than the current one.

(X4) When the current output power is lower than the demand of the electronic apparatus 1, the current output is increased to a level one step higher than the current one.

With the above-described procedure, the consumption powers of the auxiliary, i.e., the fluid feed pump 23, the air feed pump 23, and the fan 26, are appropriately controlled, thus making it the fuel consumption efficiency

It should be noted here that in the above-described example of the procedure, the output level is increased or decreased by one step in each time. However it is also possible that the level is increased or decreased to the desired level in one step by skipping some steps in accordance with an excessive or shortage amount of the output power.

FIG. 5 shows the effect of the multi-step control. In this graph, the horizontal axis indicates the power consumed by the electronic apparatus, whereas the vertical axis indicates the consumption energy of the fuel. Further, in FIG. 5, a line (a) indicates the fuel consumption amount by the auxiliary when the multi-step control is carried out, whereas a line (b) indicates the fuel consumption amount by the auxiliary when the multi-step control is not carried out. Further, a line (c) indicates a fuel consumption amount of a hypothetical case where the power consumptions by the auxiliary is zero. Lastly, a line (d) indicates the fuel consumption amount of the entire apparatus when the multi-step control is carried out, whereas a line (e) indicates the fuel consumption amount when the multi-step control is not carried out.

As shown in FIG. 5, when the multi-step control is not carried out, the fuel consumption amount by the auxiliary is maintained constant and relatively high as indicated by the line (b). By contrast, with the multi-step control of this embodiment, the auxiliary may be operated at low fuel consumption when the consumption power of the electronic apparatus 1 is low, as indicated by the line (a).

The line (c) indicates the hypothetical case where the fuel consumption of the auxiliary is zero. Here, in the case where the multi-step control is not carried out, the overall consumption amount is an addition of the amount indicated by the line (c) and the amount indicated by the line (b), and the line (e) indicates this particular case.

By contrast, in the case where the multi-step control of the embodiment is carried out, the overall consumption is only a total of the amount indicated by the line (c) and that of the line (a), as illustrated by the line (d).

In other words, with the fuel cell unit 2, the fuel indicated by the crosshatched area shown in FIG. 5 (the shaded area between the line e and line d) may be saved, thus realizing an improvement in the fuel consumption efficiency.

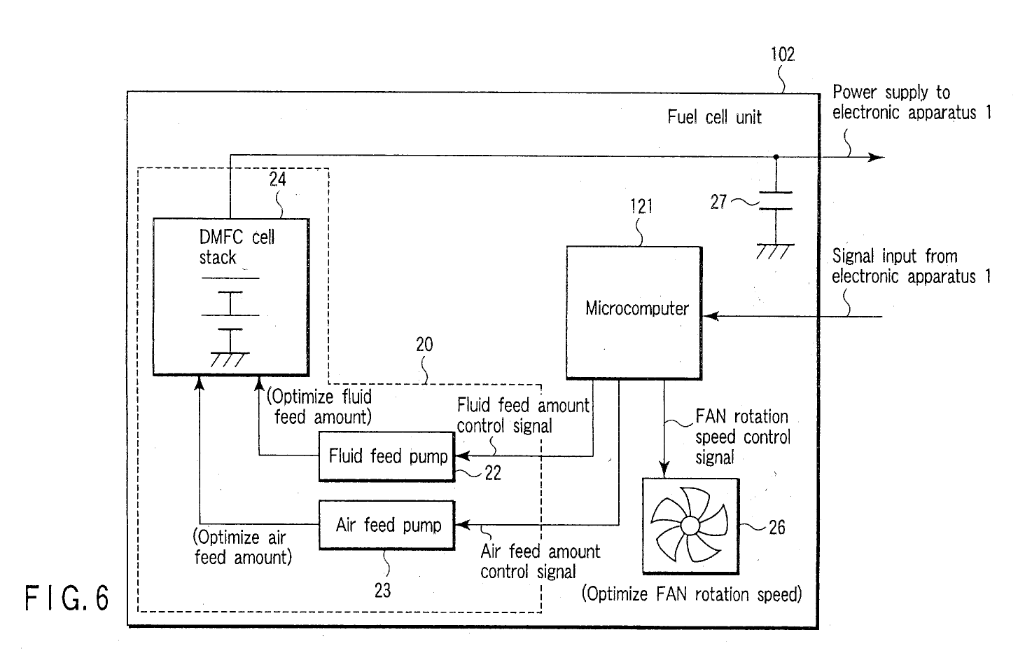

FIG. 6 shows a schematic structure of a fuel cell unit according to the second embodiment of the present invention.

A fuel cell unit 102 of the second embodiment is different from that of the first embodiment in the following respects. That is a function of inputting various kinds of signals from the electronic apparatus 1 to a microcomputer 121 is added. On the other hand, the function of detecting the output voltage and output current which is output from the DMFC cell stack 24 to the electronic apparatus 1 is omitted. Further, in accordance with the omission of the function, the current detecting resistance 25 is not provided either.

According to the second embodiment, if the microcomputer 121 has received a signal instructing it to lower the output from the electronic apparatus 1, the microcomputer 121 reduces the fuel supply amount and the air supply amount to the DMFC cell stack 24 by means of the fuel feed pump 22 and the air feed pump 23, so as to reduce the output to a level one step lower than the current one. If the microcomputer 121 has received a signal instructing to increase the output from the electronic apparatus 1, then the microcomputer 121 increases the fuel supply amount and the air supply amount to the DMFC cell stack by means of the fuel feed pump 22 and the air feed pump 23 so as to increase the output to a level one step higher than the current one.

Examples of the instructions from the electronic apparatus 1 are notifications of change in power that resulted from insertion or removal of an extension device, revision of power saving setting and revision of the processing speed of the CPU.

With the above-described structure, the power consumption by the auxiliary including the air feed pump 23 and fan 26 may be appropriately controlled as in the first embodiment.

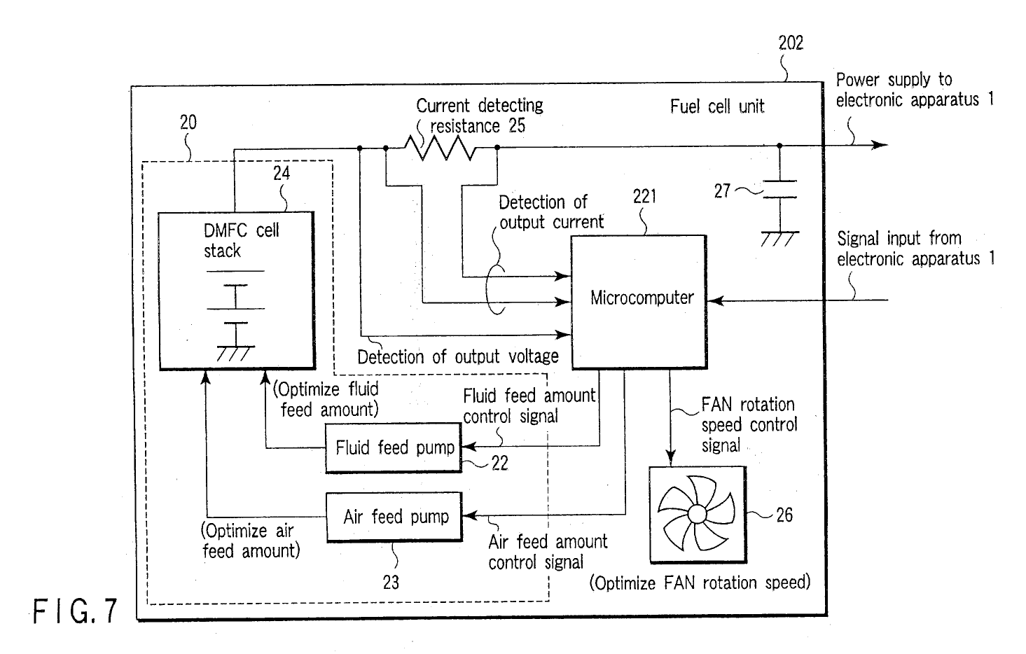

FIG. 7 shows a schematic structure of a fuel cell unit according to the third embodiment of the present invention.

A fuel cell unit 202 of the third embodiment is different from that of the first embodiment in the respect that the function of inputting various types of signals from the electronic apparatus 1 to the microcomputer 221 is added to the third embodiment. Further, the fuel cell unit 202 of the third embodiment is different from that of the second embodiment in the respect that the function of detecting the output voltage and output current from the DMFC cell stack 24 to the microcomputer 21 is not omitted, but this function is used as well.

According to the third embodiment, the microcomputer 221 serves to increase or decrease the outputs of the auxiliary basically in accordance with the output voltage and output current from the DMFC cell stack 24 to the electronic apparatus 1, that are detected by the microcomputer 221 itself, and also, in an overriding manner, when instructed by the electronic apparatus 1, the microcomputer 221 executes an increment or decrement of the outputs of the auxiliary on the basis of the instruction.

With the above-described structure, the power consumption by the auxiliary including the fuel feed pump 22, the air feed pump 23, and fan 26 may be appropriately controlled without causing an excessive load on the electronic apparatus 1.

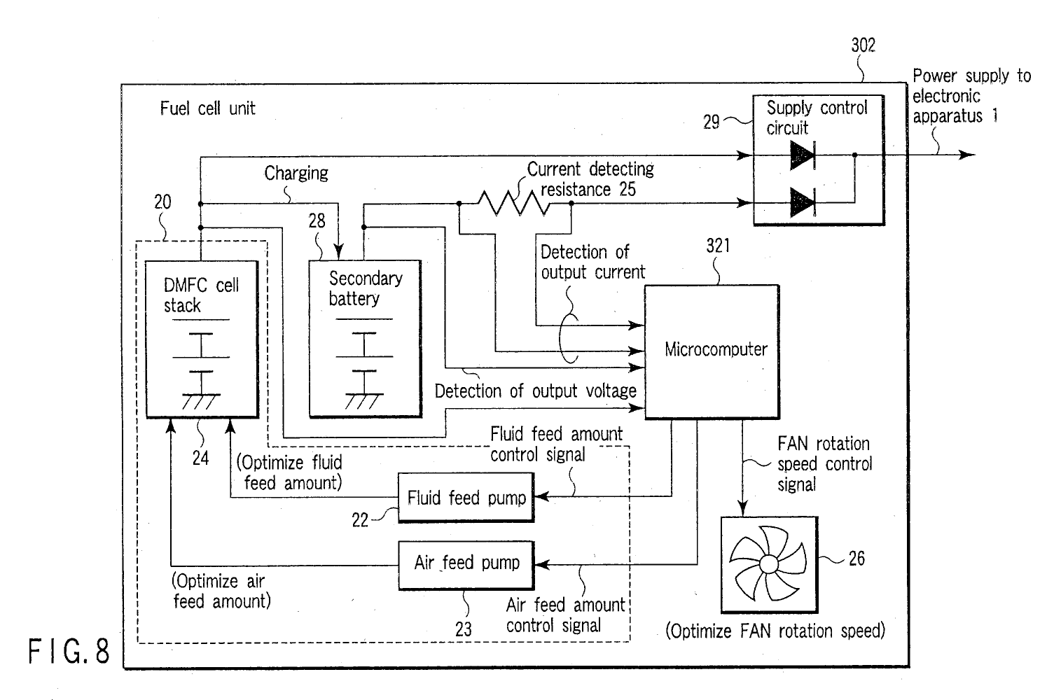

FIG. 8 shows a schematic structure of a fuel cell unit according to the fourth embodiment of the present invention.

A fuel cell unit 302 of the fourth embodiment is different from that of the first embodiment with respect to a secondary battery 28 that may be charged/discharged repeatedly by using the output power of the DMFC cell stack 24. Furthermore, the fuel cell unit 302 has a supply control circuit 29 instead of a capacitor. The capacitor is not needed because it is not required to instantaneously increase power.

In the fuel cell unit 302 of the fourth embodiment, a microcomputer 321 controls the outputs of the fluid feed pump 22 and air feed pump 23 in a multi-step manner. In the earlier described embodiments, the outputs are controlled such that the output power of the DMFC cell stack 24 always becomes equal to or higher than the power demand of the electronic apparatus 1. In this fourth embodiment, the outputs are controlled such that a predetermined portion of the shortage is compensated for by the secondary battery 28. In other words, the microcomputer 321 controls the total output electric power from the DMFC cell stack 24 and the secondary battery 28 so that it is equal to or exceeds the power demand of the electronic apparatus 1.

In consideration of the charge efficiency, as the discharge power of the secondary battery 28 becomes higher, the efficiency of use of the fuel is deteriorated. The fuel cell unit 302 of the fourth embodiment increases or decreases the output of the DMFC cell stack 24, considering the charge efficiency of the secondary battery 28 and the unnecessary consumption of the power by the auxiliary. More specifically, the output is controlled in the following manner:

(1) When the average electric power of the secondary battery 28 over a certain period of time is not less than a first predetermined value, the microcomputer 321 increases the fuel supply amount and the air supply amount, so as to increase the output of the DMFC cell stack 24 to a level one step higher than the current one.

(2) When the average electric power of the secondary battery 28 over a certain period of time is less than a second predetermined value, the microcomputer 321 decreases the fuel supply amount and the air supply amount, so as to decrease the output of the DMFC cell stack 24 to a level one step lower than the current one.

The first and second predetermined value (reference values) may be the same.

It should be noted that the supply control circuit 29 is a control circuit made of a diode OR circuit, which is designed to automatically supply, from the secondary battery 28, any power shortage of the DMFC cell stack 24.

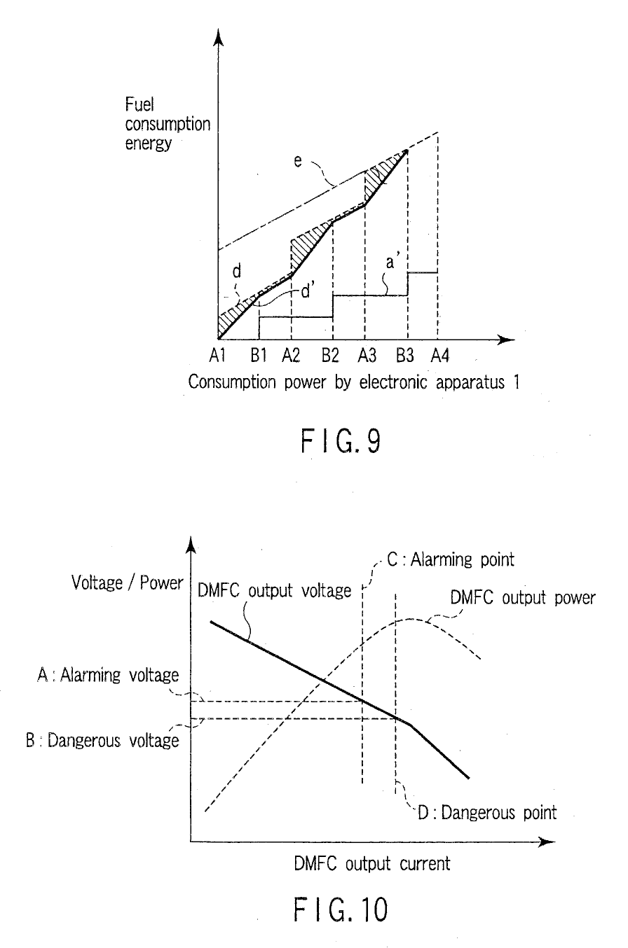

FIG. 9 illustrates the advantage of the multi-step control. A line (a′) indicates the outputs of the auxiliary in the case where the multi-step control is employed. A line (d′) indicates the fuel consumption in the case where the multi-step control is employed. The unnecessary consumption of the power produced by the DMFC cell stack, that is used by the auxiliary, may be suppressed in each area defined between An and Bn. The shortage resulting in this energy saving operation is made up by the secondary battery 28. In short, the fuel supply amount indicated by the shaded areas in FIG. 9 may be further saved as compared to the fuel supply unit 2 of the first embodiment. Thus, the fuel cell unit 302 achieves a further improvement of the fuel use efficiency.

In the meantime, if the microcomputer 321 detects that the battery power of the secondary battery 28 falls below a predetermined value, the secondary battery 28 is started to charge by the output power of the DMFC cell stack 24. The microcomputer 321 makes the secondary battery 28 stop outputting the electric power during the charging of the secondary battery 28. Therefore, as only the DMFC cell stack 24 provides the electronic apparatus 1 with the electric power at this time, the output electric power of the DMFC cell stack 24 is equal to the sum of the electric demand of the electronic apparatus 1 and electric power for recharging, or more.

For the lack of the output of the secondary battery 28 and the charging thereof, the microcomputer 321 controls the auxiliary so that the output electric power of DMFC cell stack is increased to a level one step higher than the current one.

Under the recharging condition, it may be necessary in this case to control the auxiliary such that the output electric power will be sufficient when the electric demand of the electronic apparatus 1 is increased.

As shown in FIG. 10, the output power of the DMFC stack cell 24 increases up to certain point, namely dangerous point D, when the output current of the DNFC cell stack 24 increase. However, after the dangerous point D, the output power of the DMFC stack cell 24 starts to decrease. This means that the efficiency which the fuel generates electric power is deteriorated after the dangerous point D.

The microcomputer 321 monitors the voltage of the DMFC cell stack 24, because the voltage of the DMFC cell stack 24 depends upon the output power of the DMFC cell stack 24, as shown in FIG. 10.

Dangerous voltage B is a voltage level corresponding to the dangerous point D. Also, alarming voltage A is set as a voltage level corresponding to alarming point C for warning that the dangerous point D is close.

If the microcomputer 321 detects an alarming voltage A, then the charging current to the secondary battery 28 is reduced. If the microcomputer 321 detects a dangerous voltage B, then the charging is stopped immediately since the fuel supply amounts of the auxiliary are reached the upper limit. On the other hand, if the microcomputer 321 detects the output voltage is higher than the alarming voltage A, then the charging current is increased.

With this structure, the charge to the secondary battery 28 by the DMFC cell stack 24 may not be frequently cut off.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An electronic apparatus, comprising:
a fuel cell for generating electric power, the fuel cell having a reaction portion and an auxiliary mechanism for fuel supply to the reaction portion;
an electronic device being operable with the electric power provided from said fuel cell; and
a control unit coupled to the auxiliary mechanism, for controlling an amount of fuel supply by the auxiliary mechanism in a multi-step manner.

2. An electronic apparatus according to claim 1, wherein the auxiliary mechanism includes:
a fluid fuel tank,
a fluid feed pump coupled between the fluid fuel tank and the reaction portion, and
an air feed pump.

3. An electronic apparatus according to claim 2, further comprising:
means for detecting an output electric power of the reaction portion, and
said control unit being operable for controlling operations of said fluid feed pump and said air feed pump to adjust the fuel supply based on the output electric power detected by said detecting means.

4. An electronic apparatus according to claim 1, wherein said control unit includes means for receiving an input signal from said electronic device, said control unit being operable for controlling the auxiliary mechanism to maximize the amount of the fuel supply when said receiving means receives a signal indicative of a power-on state of said electronic device.

5. An electronic apparatus according to claim 1, further comprising a fan which prevents a condensation of vapor caused by power generation and a chemical reaction of said fuel cell.

6. An electronic apparatus according to claim 5, wherein said control unit is operable for controlling a rotation speed of said fan in accordance with an output electric power of said fuel cell.

7. A cell unit, comprising:
a cell stack;
an auxiliary mechanism for fuel supply to said cell stack; and
a control unit coupled to the auxiliary mechanism, for controlling an amount of fuel supply by the auxiliary mechanism in a multi-step manner.

8. A cell unit according to claim 7, wherein the auxiliary mechanism includes:
a fluid fuel tank,
a fluid feed pump coupled between the fluid fuel tank and the reaction portion, and
an air feed pump.

9. A cell unit according to claim 8, further comprising means for detecting an output electric power of said cell stack, and
said control unit being operable for controlling operations of said fluid feed pump and said air feed pump to adjust the fuel supply based on the output electric power detected by said detecting means.

10. A cell unit according to claim 7, wherein said control unit is operable for controlling said auxiliary mechanism to maximize the fuel supply at that time of starting use of the cell unit

11. A cell unit according to claim 7, further comprising:
an output portion for outputting the electric power to an electronic device, and an input portion for receiving a signal indicative of the electric demand of the electronic device, and
said control unit being operable for controlling said auxiliary mechanism to adjust the fuel supply based on said signal.

12. A cell unit according to claim 7, further comprising a fan which prevents a condensation of vapor caused by power generation and a chemical reaction of said cell stack.

13. A cell unit according to claim 12, wherein said control unit is operable for controlling a rotation speed of said fan in accordance with an output electric power of said cell stack.

14. A cell unit, comprising:
a fuel cell which includes a reaction portion and an auxiliary mechanism for fuel supply to the reaction portion;
a secondary cell for supplementing shortage of the electric power output by said fuel cell; and
a circuit coupled to said fuel cell and said secondary cell, for outputting an amount of fuel supply to the auxiliary mechanism in a multi-step manner.

15. A cell unit according to claim 14, wherein said control unit is operable for increasing the fuel supply amount to said auxiliary mechanism when an average output electric power of said secondary cell within a predetermined period of time exceeds a first reference value, and for decreasing the fuel supply amount to said auxiliary mechanism when an average output voltage of said secondary cell within a predetermined period of time falls below a second reference value.

16. A cell unit according to claim 14, further comprising means for charging said secondary cell with electric power from said fuel cell, and said control unit being operable for decreasing a charge current to said secondary cell when an output voltage of said fuel cell becomes a first value, and for stopping charging said secondary cell when the output voltage of said fuel cell becomes a second value which is lower than the first value.

17. A method of controlling operation of a fuel cell having a reaction portion and an auxiliary mechanism for fuel supply to the reaction portion, comprising the steps of:
detecting an output electric characteristic of the fuel cell; and
controlling a fuel supply amount by the auxiliary mechanism in a multi-step manner corresponding to the output electric characteristic detected.

18. A method of controlling an operation of a fuel cell having a reaction portion and an auxiliary mechanism for fuel supply to the reaction portion, and a secondary cell, comprising the steps of:
detecting an output electric characteristic of the secondary cell and an output electric characteristic of the fuel cell; and
controlling a fuel supply amount to the auxiliary mechanism in a multi-step manner corresponding to the output electric characteristic of both the secondary cell and the fuel cell.

19. A method according to claim 18, wherein said controlling step includes the steps of increasing the fuel supply amount by said auxiliary mechanism when an average output electric power of said secondary cell within a predetermined period of time exceeds a first reference value, and decreasing the fuel supply amount by said auxiliary mechanism when an average output electric power of said secondary cell within a predetermined period of time falls below a second reference value

20. A method according to claim 18, further comprising the steps of:
charging the secondary cell with electric power from said fuel cell,
decreasing a charge current to the secondary cell when an output voltage of the fuel cell becomes a first value, and
stopping charging the secondary cell when the output voltage of said fuel cell becomes a second value which is lower than the first value.

21. A method of supplying electric power, to an electronic apparatus from an fuel cell having a reaction portion and an auxiliary mechanism for supplying fuel to the reaction portion, comprising the steps of:
providing the fuel cell with a signal indicative of an electric demand of the electronic device; and
in response to said signal controlling the auxiliary mechanism so as to control the fuel supply to the reaction portion.

22. A method according to claim 21, wherein the controlling step includes the step of selecting one of a plurality of fuel supply amounts.
